(19) United States
(12) Patent Application Publication
(10) Pub. No.: US 2010/0276496 A1
(43) Pub. Date: Nov. 4, 2010

(54) CHIP CARD COMPRISING A DISPLAY

(75) Inventors: Peter Slikkerveer, Waalre (NL); Pawel Musial, Gdynia (PL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/742,147

(22) PCT Filed: Nov. 10, 2008
(86) PCT No.: PCT/IB2008/054698

§ 371 Date: May 10, 2010

(30) Foreign Application Priority Data
Nov. 12, 2007 (EP) 07120457.2

(51) Int. Cl. G06K 19/07

(52) U.S. Cl. 235/492

(57) ABSTRACT

A chip card (1) comprises a chip card controller (3), a display (6), a timing device (12), and a display driver (5) operatively coupled to the chip card controller (3) and to the display (6). The display driver (5) is configured to drive the display (6). The chip card (1) comprises a timing device (12) that is configured to wake up at least parts of the chip card (1).

### FIELD OF THE INVENTION

The invention relates to a chip card comprising a display.

### BACKGROUND OF THE INVENTION

In this context, a chip card is any pocket-sized card with an embedded integrated circuit that comprises hardware logic, a memory or a microcontroller/microprocessor which can process information. Chip cards can be categorized in accordance with different criteria. Particularly, chip cards can be categorized as memory-chip cards that comprise a relatively simple logic and as processor-chip cards that comprise, for instance, an operation system. Particularly processor-chip cards can receive an input signal which is processed, by way of an integrated circuit application, and deliver an output signal. Generally, chip cards can be contactless or contact chip cards, or can be a combination of both.

Contact chip cards may include a contact module on their fronts. This contact module may be gold plated and has a size of approximately 1 cm by 1 cm and may contain a chip at the back. The contact chip card may communicate with a reader. When inserted into the reader, electrical connectors of the reader contact the contact module for reading information from and writing information back to the chip card. Since normally the chip card does not include a battery, energy is supplied to the contact chip card by the reader. Contact chip cards are, for instance, standardized by ISO/IEC 7816 or ISO/IEC 7810.

In a contactless chip card, the integrated circuit communicates with the reader in a contactless manner, for instance through Radio-frequency identification (RFID). Contactless chip cards are, for instance, standardized by ISO/IEC 14443 or ISO 15693. Contactless chip cards are also known as transponders which may or may not include an active energy source, such as a battery. Transponders not having a battery are also known as passive transponders and transponders comprising a battery are known as active transponders.

International application for patent No. 94/20929 discloses a chip card that comprises an electronic data memory, an interface means connected to the data memory, to allow access to a reader, and a data display operable to display information indicative of the contents of the data memory.

Chip cards may be used, inter alia, as banking cards, transportation ticketing, loyalty cards, or e-passports. Because of this, a relatively high security level against fraudulent tampering of the card must be assured. Even though the data display may be meant to decrease danger of fraud and tempering of the usage of the chip card, the data display as an additional component potentially allows additional methods for fraud and tempering. Additionally, the display potentially increases power consumption.

### OBJECT AND SUMMARY OF THE INVENTION

It is an object of the present invention to provide a chip card comprising a display, which potentially uses less electric energy and whose security level against fraudulent misuse is increased.

The object is achieved in accordance with the invention by means of a chip card comprising a chip card controller, a display, a timing device configured to wake up at least parts of the chip card, and a display driver operatively coupled to the chip card controller and to the display, and being configured to drive the display.

The inventive chip card comprises the display that may, for instance, be an electrophoretic display, an electrochrome display, or a Liquid crystal based display. In order to drive the display, the chip card needs the display driver. A display driver may be a demultiplexer at the direct contact of the display. A display driver may also or alternatively determine which voltage should be where on the display. This functionality may also be referred to as display controller. Furthermore, the inventive chip card comprises the timing device, for instance, a timer or a clock, particularly a real-time clock, which is configured to wake up at least parts of the inventive chip card. The timing device may particularly be an integral part of the display driver. This may be achieved by forming the display driver as a single integrated circuit which includes the timing device.

The timing device is configured to wake up at least parts of the inventive chip card. Thus, the timing device is configured to wake up the entire chip card or only one or some of its components, such as its chip card controller or its display driver.

The timing device can be used for several purposes. The timing device may be configured to generate a signal at pre-defined time instances, periodically, or after a pre-defined time period after an internal action of the chip card, or at a certain time/date as it is possible with a real time clock. The signal is then used for waking up the desired parts of the chip card. Particularly, when the timing device is the real time clock, an alarm function of the real time clock could be used as a signal for waking up the chip card or at least parts of the chip card.

The signal generated by the timing device may, for instance, be used to periodically wake up the entire inventive chip card or parts thereof, particularly its chip card controller, or to wake up the chip card or parts thereof at pre-defined time instances. The timing device may also be used to wake up the chip card or parts thereof after a pre-defined time period after a certain action of the chip card. The timing device may particularly be used to initiate clearing and/or resetting the display after a pre-defined time period. Then, the part of the chip card to be woken up is the display. This may be achieved by waking up the chip controller which then can send a signal to the display driver to clear and/or reset the display. The timing device can also be configured to control directly the display driver to reset and/or clear the display. This embodiment of the inventive chip card is particularly advantageous if the display is a bistable display which continues displaying its content without a power source.

In one embodiment of the inventive chip card, this integrated circuit includes the timing device, but not the chip card controller. This embodiment results in a relatively high level of integration of the inventive chip card, potentially decreasing production cost. On the other hand, the separation of the chip card controller and the display driver potentially increases the level of security. A full integration of most or all components, especially an integration of the chip card controller and the display driver including the timing device into a single integrated circuit results in an increased number of outputs, potentially alleviating eavesdropping of the entire chip card.

In one embodiment, the inventive chip card further comprises access to at least one electric power source operatively coupled to the timing device and/or to the display device, wherein the display driver further comprises, as an integral part, a power management functionality configured to manage electric power that is available from the at least one power source for at least the timing device. In this embodiment, the inventive chip card includes power management capability particularly intended to reduce power consumption of the chip card. The power management functionality is also an integral part of the display driver. This may particularly be achieved by integrating the power management functionality into the single integrated circuit that may form the display driver. While the timing device is running, the power for the remaining parts of the chip card, besides the power management functionality or at least a wake-up circuit of the power management functionality, might be turned off.

The power management functionality is configured to manage at least the electric power for the display driver, i.e. the display driver is configured to perform its own power management. In one embodiment of the inventive chip card, the power management functionality is also responsible to carry out the power management for the chip card controller. This potentially reduces further electric power consumption of the inventive chip card.

The power management functionality may particularly be configured to turn off power for the chip card controller while the display writes information to the display and/or displays display information. Then, the chip card controller, which may be, for instance, a microprocessor or a microcontroller, is only powered when absolutely necessary.

The inventive chip card may particularly be configured to communicate with an external reader utilizing its chip card controller. Then, the inventive chip card comprises at least one appropriate communication interface. The inventive chip card may communicate with the reader contactlessly or in a contactbound manner, and thus may include a contactless communication interface or a contact interface. The contact communication interface may be in accordance with ISO 7816 and the contactless communication interface may comprise an antenna and may be in accordance with ISO 14443. It is also possible that the inventive chip card comprises both, a contact communication interface and a contactless communication interface.

When communicating with the reader, the inventive chip card may be powered via the appropriate communication interface. Thus, the power source of the inventive chip card may be formed by a communication interface. The power source, however, may also be a battery which may be non-chargeable or be chargeable utilizing, for instance, power from the communication interface.

If the inventive chip card comprises access to at least two different power sources, then the power management functionality may be configured to select one of the power sources in accordance with availability of the power sources and/or in accordance with pre-defined criteria. For instance, the power management functionality may be configured to select, if the chip card is activated, only the battery as the power source for the chip card if no power is available via the communication interface. It is also possible to switch from the battery as the power source for the chip card to the communication interface as the power source for the chip card if power becomes available via the communication interface. This enhances the lifetime of the battery.

If the inventive chip card comprises the contact communication interface, then the power management functionality of the display driver may be configured to select the contact communication interface as the preferred power source for the chip card. When including the contact communication interface, then power is delivered to the chip card from the reader in a contactbound manner. This results in a relatively strong power source potentially enhancing reliable power delivery to the inventive chip card.

The power management functionality, when applied, is integrated into the display driver which may be formed as the single integrated circuit. In one embodiment of the inventive chip card, this integrated circuit includes the timing device and, if equipped with the power management functionality, also the power management functionality, but not the chip card controller. This embodiment results in a relatively high level of integration of the inventive chip card, potentially decreasing production cost. On the other hand, the separation of the chip card controller and the display driver potentially increases the level of security. A full integration of most or all components, especially an integration of the chip card controller and the display driver including the timing device and the power management functionality into a single integrated circuit results in an increased number of outputs, potentially alleviating eavesdropping of the entire chip card. Additionally, since according to this embodiment, the chip card controller and the display driver are not integrated into a single integrated circuit, the power management functionality, if included into the inventive chip card, can relatively easily shut off the chip card controller while still activating the display driver. This results in a further improved power management, because updating the display by the display driver may take a relatively long time and support by the chip card controller is not needed during this time.

### BRIEF DESCRIPTION OF THE DRAWINGS

The invention will be described in greater detail hereinafter, by way of non-limiting examples, with reference to the embodiments shown in the drawings.

FIG. 1 is a chip card comprising a display;

FIG. 2 is a flow chart illustrating a power strategy of the chip card; and

FIG. 3 is a flow chart illustrating a power takeover strategy of the chip card.

### DESCRIPTION OF EMBODIMENTS

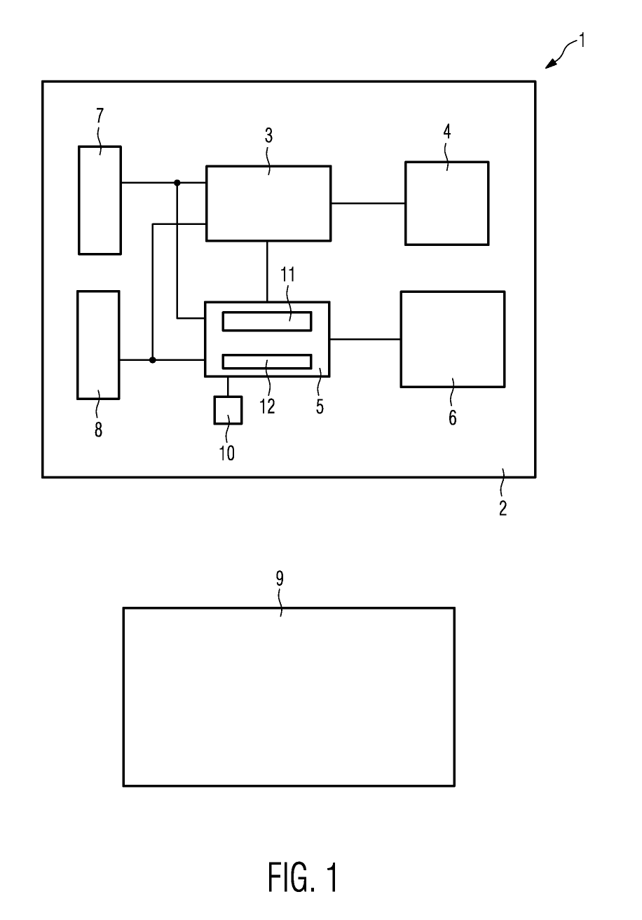

FIG. 1 shows a chip card 1 comprising a substrate 2, a microcontroller 3, a memory 4, a display driver 5, and a display 6 operatively coupled to the display driver 5. The display driver 5 and the memory 4 are operatively coupled to the microcontroller 3, and the microcontroller 3, the memory 4, the display driver 5, and the display 6 are embedded in the substrate 2. The memory 4 may be an EEPROM, the substrate 2 may be made from plastics, and the display 6 may be an electrophoretic display.

For the exemplary embodiment, the chip card 1 comprises a contact communication interface 7 and a contactless communication interface 8, each operatively coupled to the microcontroller 3 and to the display driver 5. The communication interfaces 7, 8 are embedded in the substrate 2. The contact communication interface 7 may be, for instance, in accordance with ISO 7816 and the contactless communication interface 8, which may comprise an antenna, may be, for instance, in accordance with ISO 14443. Utilizing its communication interfaces 7, 8, the chip card 1 can communicate with a reader 9 that comprises an appropriate communication interface not explicitly shown in the figures.

If the reader 9 comprises a contact communication interface, then the chip card 1 may be inserted into the reader 9 such that the contact communication interface of the reader 9 contacts the contact communication interface 7 of the chip card 1 in a manner per se known in the art. Then, communication between the reader 9 and the chip card 1 can be carried out via the contact communication interface 7. Furthermore, electric energy for the chip card 1 can also be supplied via the contact communication interface 7.

If the reader 9 comprises a contactless communication interface, then the reader 9 can communicate contactlessly with the chip card 1 utilizing the contactless communication interface 8. Communication may then be carried out utilizing Radio Frequency Identification (RFID) per se known in the art. The chip card 1 may then be powered utilizing the field emitted by the reader 9.

For the exemplary embodiment, the chip card 1 further comprises a battery 10 embedded in the substrate 2. The battery 10 is an example of an active power source and may be a chargeable or a non-chargeable battery. Therefore, the chip card 1 may be powered by the battery 10 or via the communication interfaces 7, 8.

For the exemplary embodiment, the display driver 5 is formed by a single integrated circuit that does not include the microcontroller 3, the memory 4, and the communication interfaces 7, 8. Furthermore, the chip card 1 comprises power management functionality integrated into the integrated circuit forming the display driver 5. The power management functionality is indicated by a power management unit 11 in FIG. 1. Besides the communication interfaces 7, 8, the battery 10 is operatively coupled to the display driver 5 such that its power management unit 11 can perform power management of the chip card 1 as will be explained below.

The display 6 is intended to display information stored or calculated by microcontroller 3, for instance, in the memory 4. The microcontroller 3 controls the display driver 5 such that it drives appropriately the display 6.

For the exemplary embodiment, the chip card 1, i.e. its components can be powered by three different power sources, namely the battery 10, or via the communication interfaces 7, 8 when communicating with the reader 9. The purpose of the power management unit 11 is, inter alia, to choose the appropriate power source.

If the reader 9 is a contact reader, then the chip card 1 may be inserted into the reader 9 such that the contact communication interfaces 7 of the reader 9 and the chip card 1 make contact. Then, not only communication between the reader 9 and the chip card 1 is carried out via the contact communication interface 7, but also electric power is delivered via the contact communication interface 7 to the chip card 1. If operated in this mode, the system, i.e. the display driver 5 including its power management unit 11 and the microcontroller 3 wake up upon detecting an electric supply voltage at the contact communication interface 7. For the exemplary embodiment, the electric power is fed directly from the contact communication interface 7 to the microcontroller 3 and to the display driver 5.

If the reader 9 is a contactless reader, then the chip card 1 communicates with the reader 9 via its contactless communication interface 8 when the chip card 1 is in the vicinity of the reader 9. The reader 9 emits a field which powers the chip card 1. For the exemplary embodiment, the electric power is fed directly from the contactless interface 8 to the microcontroller 3 and to the display driver 5 including its power management unit 11.

The chip card 1 further comprises a real-time clock 12 which, for the exemplary embodiment, is an integral part of the display driver 5 by being integrated into the single integrated circuit forming the display driver 5. The real-time clock 12 may also be a separate chip. The real-time clock 12 may be programmed to generate and send a signal at pre-defined time instances, periodically, or after a pre-defined period of time the display 6 has displayed some display information or at a preprogrammed time/day, see alarm function RTC (Day-time, week, . . . ). The signal generated by the real-time clock 12 may be used to wake-up the microcontroller 3 and/or the display driver 5, to display some display information on the display 6, or to clear and/or reset the display 6 after the pre-defined time period. When being configured to clear and/or reset the display 6 after the pre-defined time period, the chip card 1 can be configured such that the real time clock 12 wakes up the microcontroller 3 such that the microcontroller 3 can control the display driver 5 in order to clear and/or reset the display 6. The real time clock 12 can also be configured to only wake up the display driver 5 to clear and/or reset the display 6 without waking up the microcontroller 3.

For the exemplary embodiment it is possible that even though the chip card 1 is not in contact with the reader 9 the display 6 is turned on by the real-time clock 12. For the exemplary embodiment, the power management unit 11 then wakes up the display driver 5 in response to the signal of the real-time clock 12. Then, the display driver 5 wakes up the microcontroller 3 by powering it utilizing the battery 10 and utilizing its power management functionality. If the voltage level of the battery 10 is too high for the microcontroller 3, then the display driver 5 may include a voltage converter configured to down convert the battery voltage to a level suitable for the microcontroller 3. The voltage converter may be integrated into the single integrated circuit that forms the display driver 5 or to save power at the microcontroller 3. The voltage converter may also be used if the voltage available at the communication interfaces 7, 8 are too high for the microcontroller 3.

Upon receiving electric power, the microcontroller 3 retrieves display information stored in the memory 4 and sends the retrieved display information to the display driver 5. The microcontroller 3 may also or alternatively perform a mathematical operation on the data before sending it to the display driver 5. The display driver 5 then writes the display information to the display 6 for displaying. Furthermore, after having sent the display information to the display driver 5, the microcontroller 3 sends a signal to the display driver 5 to turn off the power supply for the microcontroller 3. After having written the display information to the display 6, the display driver 5 shuts off automatically. Furthermore, after having displayed the display information for the pre-defined time period, the real-time clock 12 initiates the automatic clearing of the display 12.

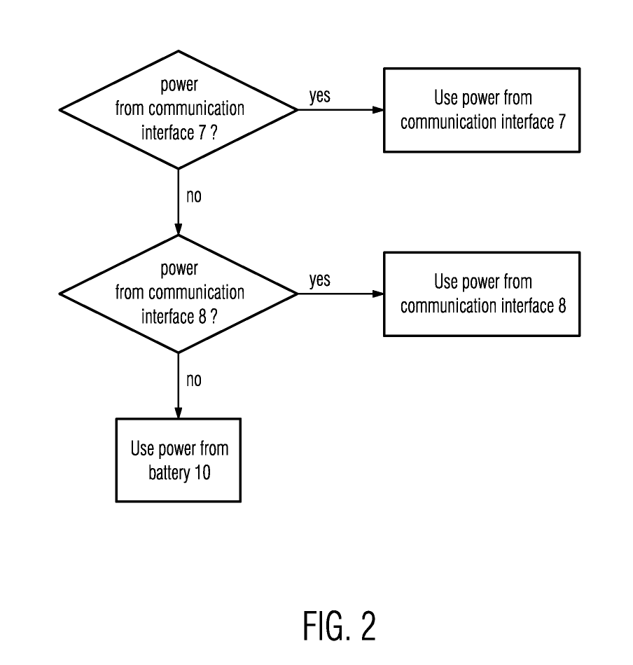

For the exemplary embodiment, the power management unit 11 carries out, after being activated, the following power priority strategy if more than one power source is available for the chip card 1. The power strategy is summarized in FIG. 2.

If more than one power source is available, then the power management unit 11 selects the strongest power source for powering the chip card 1, particularly the microcontroller 3, the display driver 5, and the real-time clock 12. Should power be available via the contact communication interface 7, then the power management unit 11 always selects this power source such that the chip card 1, i.e. its microcontroller 3 and the display driver 5 are powered via the contact communication interface 7.

If no power is available via the contact communication interface 7, then the power management unit 11 checks if power for the microcontroller 3 and the display driver 5 is available via the contactless communication interface 8. If this is the case, then the power management unit 11 selects the contactless communication interface 8 to power the chip card 1.

If power is neither available via the contactless communication interface 8 nor via the contact communication interface 8, then the power management unit 11 selects the battery 10 to power the chip card 1.

Additionally, the chip card 1 is configured to power the real-time clock 12 by the battery 10 as long as no power is available via the communication interfaces 7, 8.

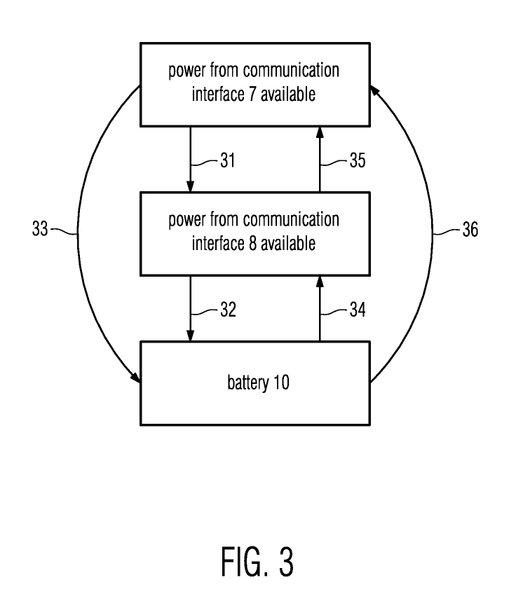

During operation of the chip card 1 it may happen that the power source currently used is lost or that a stronger power source than currently used becomes available. For the exemplary embodiment, the power management unit 11 further implements the following power takeover strategy which is summarized in FIG. 3:

A) Assuming, the chip card 1 is initially powered via the contact communication interface 7 and power is lost via the contact communication interface 7, but power is available via the contactless communication interface 8. If information to be displayed on the display 6 has been completely received from the reader 9, then this information is displayed utilizing the display 6 and the display driver 5 is powered via the contactless interface 8, otherwise the chip card 1 is shut off. This is indicated by an arrow 31 in FIG. 3.

B) Assuming, the chip card 1 is initially powered via the contactless communication interface 8 and power is lost via the contactless communication interface 8. If information to be displayed on the display 6 has been completely received from the reader 9, then this information is displayed utilizing the display 6 and the display driver 5 is powered by the battery 10, otherwise the chip card 1 is shut off. This is indicated by an arrow 32 in FIG. 3.

C) Assuming, the chip card 1 is initially powered via the contact communication interface 7, power is lost via the contact communication interface 7, and no power is available via the contactless communication interface 8. If information to be displayed on the display 6 has been completely received from the reader 9, then this information is displayed utilizing the display 6 and the display driver 5 is powered by the battery 10, otherwise the chip card 1 is shut off. This is indicated by an arrow 33 in FIG. 3.

D) Assuming, the chip card 1 is currently powered by the battery 10. If power becomes available via the contactless communication interface 8, then the power management unit 11 selects that the chip card 1 is powered via the contactless communication interface 8. This is indicated by an arrow 34 in FIG. 3.

E) Assuming, the chip card 1 is currently powered via the contactless communication interface 8 and power becomes available via the contact communication interface 7. Then, the reader 9 will reset the microcontroller 3 via the contact communication interface 7 and the chip card 1 will be powered by the contact communication interface 7. This is indicated by an arrow 35 in FIG. 3.

F) Assuming, the chip card 1 is currently powered by the battery 10. If power becomes available via the contact communication interface 7, then the power management unit 11 selects that the chip card 1 is powered via the contact communication interface 7. This is indicated by an arrow 36 in FIG. 3.

The reader 9 will reset the microcontroller 3, but the display driver 5 will continue to operate using the contact power source. This is useful, because updating the display 6 by the display driver 5 may take a relatively long time and support by the microcontroller 3 is not needed during this time.

The chip card 1 described above comprises the two communication interfaces 7, 8. This is not absolutely necessary. The chip card 1 can also comprise only one of the communication interfaces. Furthermore, the chip card 1 does not necessarily need the battery 10. Additionally, the button 12 and the button interface 13, generally an input device with associated input interface are optional.

Instead of the real-time clock 12 the chip card 1 can comprise a timer which is an integral part of the driver display 5 by being integrated into the single integrated circuit forming the display driver 5. This timer may particularly be configured to generate and send a signal after a pre-defined period of time after having been activated. This signal may be used to trigger a desired action of the chip card 1, such as clearing the display 6.

Finally, it should be noted that the aforementioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. A chip card comprising:
a chip card controller;
a display;
a timing device configured to wake up at least parts of the chip card; and
a display driver operatively coupled to the chip card controller and to the display, and being configured to drive the display.

2. The chip card of claim 1, wherein the timing device is an integral part of the display driver.

3. The chip card of claim 1, wherein the timing device is at least one of a clock, particularly a real-time clock, or a timer.

4. The chip card of claim 1, wherein the display driver is formed as a single integrated circuit including the timing device, but excluding the chip card controller.

5. The chip card of claim 1, wherein the timing device is configured to generate a signal at pre-defined time instances, periodically, at a certain time, a certain day, or after a pre-defined time period after an internal action of the chip card in order to wake up at least parts of the chip card.

6. The chip card of claim 1, wherein the timing device is configured to initiate clearing and/or resetting the display utilizing the display driver display directly or utilizing the chip card controller.

7. The chip card of claim 1, further comprising access to at least one electric power source operatively coupled to the display device; the display driver further comprising, as an integral part, a power management functionality configured to manage electric power that is available from the at least one power source for at least the timing device.

8. The chip card of claim 7, wherein the power management functionality is configured to manage electric power for the chip card controller.

9. The chip card of claim 8, wherein the power management functionality is configured to turn off power for the chip card controller while the display driver writes information to the display.

10. The chip card of claim 7, comprising access to at least two different power sources, wherein the power management functionality is configured to select one of the power sources in accordance with availability of the power sources.

11. The chip card of claim 10, wherein the at least one power source is at least one of
a contact communication interface of the chip card configured to allow communication of the chip card controller with a contact reader;
a contactless communication interface of the chip card configured to allow communication of the chip card controller with a contactless reader;
a capacitor of the chip card;
a piezo button of the chip card;
a solar cell of the chip card; or
a battery (10) of the chip card.

12. The chip card of claim 11, wherein the power management functionality of the display driver is configured to select, if the chip card is activated, only the battery as the power source for the chip card if no power is available via the communication interface.

13. The chip card of claim 11, wherein the power management functionality of the display driver is configured to select the contact communication interface as the preferred power source for the chip card.
